(19) United States
(12) Patent Application Publication
(10) Pub. No.: US 2026/0057013 A1
(43) Pub. Date: Feb. 26, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Mamoru INOUE, Tokyo (JP)

(21) Appl. No.: 19/208,342

(22) Filed: May 14, 2025

(30) Foreign Application Priority Data
Aug. 20, 2024 (JP) 2024-139103

(51) Int. Cl. G06F 16/9035; G06F 16/3329; G06F 16/34; G06F 16/906

(52) U.S. Cl. CPC G06F 16/9035; G06F 16/33295; G06F 16/345; G06F 16/906

(57) ABSTRACT

An information processing apparatus includes, a setting unit that sets a condition for a user classified into a user group from input data; a selecting unit that selects a to-be-analyzed group based on a user attribute corresponding to each condition with respect to each the condition; a scoring unit that scores each user meeting the condition based on a behavior history of each user corresponding to each condition with respect to each the condition; an extractor that extracts a warm-prospect user having a higher score than other users in the to-be-analyzed group based on a result of scoring by the scoring unit; and a provision unit that selects a to-be-compared user, specifies information on a characteristic behavior of the warm-prospect user, transmits information on the specified characteristic behavior and attribute information indicating the attribute corresponding to the warm-prospect user to a terminal device, and provides the specified and attribute information.

### CROSS-REFERENCE TO RELATED APPLICATIONS

The present application claims priority to and incorporates by reference the entire contents of Japanese Patent Application No. 2024-139103 filed in Japan on Aug. 20, 2024.

### BACKGROUND OF THE INVENTION

### 1. Field of the Invention

The present application relates to an information processing device, an information processing method, and an information processing program.

### 2. Description of the Related Art

Various technologies that relate to delivery of content, such as advertisements, have been provided. For example, a technology that relates to advertisement campaigns in which advertisements are delivered based on conditions, such as a budget, a period, and targets of delivery, has been proposed (for example, refer to Japanese Patent No. 6621954).

The conventional technology however has room for improvement in assisting selection of recipients of delivery of content, such as an advertisement. For example, while appropriate selection of recipients of delivery of an advertisement is desired, selecting recipients of delivery is not necessarily easy due to various factors, such as a cost of implementation, a record of delivery, and requests of the advertiser.

### SUMMARY OF THE INVENTION

An information processing apparatus includes, a setting unit that sets a condition for a user who is classified into a user group from input data that is input by an operator; a selecting unit that selects a to-be-analyzed group based on an attribute of a user corresponding to each condition with respect to each the condition; a scoring unit that scores each user who meets the condition based on a behavior history of each user corresponding to each condition with respect to each the condition; an extractor that extracts a warm-prospect user whose score is higher than those of other users in the to-be-analyzed group based on a result of scoring performed by the scoring unit; and a provision unit that selects a to-be-compared user who is to be compared with the warm-prospect user from the to-be-analyzed group, specifies information on a characteristic behavior of the warm-prospect user from a result of comparison between behavior information on the warm-prospect user and behavior information on the to-be-compared user, transmits information on the specified characteristic behavior and attribute information indicating the attribute corresponding to the warm-prospect user to a terminal device that the operator uses, and thus provides the specified information and the attribute information on the operator.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for describing an example of information processing according to an embodiment;

FIG. 2 is a diagram for specifically describing an overview of the information processing according to the embodiment;

FIG. 3 is a diagram for specifically describing the overview of the information processing according to the embodiment;

FIG. 4 is a diagram for specifically describing the overview of the information processing according to the embodiment;

FIG. 5 is a diagram for specifically describing the overview of the information processing according to the embodiment;

FIG. 6 is a diagram for specifically describing the overview of the information processing according to the embodiment;

FIG. 7 is a diagram for specifically describing the overview of the information processing according to the embodiment;

FIG. 8 is a diagram for specifically describing the overview of the information processing according to the embodiment;

FIG. 9 is a diagram illustrating an example of suggestion information according to the embodiment;

FIG. 10 is a diagram illustrating an example of a system configuration of an information processing system according to the embodiment;

FIG. 11 is a diagram illustrating an example of a configuration of an information processing device according to the embodiment;

FIG. 12 is a diagram illustrating an overview of user information that is stored in a user information storage unit according to the embodiment;

FIG. 13 is a diagram illustrating an overview of a behavior history that is stored in a behavior history storage unit according to the embodiment;

FIG. 14 is a flowchart illustrating an example of a procedure of information processing that is executed by the information processing device according to the embodiment; and

FIG. 15 is a hardware configuration diagram illustrating an example of a computer that implements functions of the information processing device according to the embodiment.

### DETAILED DESCRIPTION OF THE PREFERRED EMBODIMENTS

A mode for carrying out an information processing device, an information processing method, and an information processing program (referred to as “embodiment” below) according to the present application will be described in detail below with reference to the accompanying drawings. Note that the embodiment does not limit the information processing device, the information processing method, and the information processing program according to the present application. It is possible to combine each embodiment as appropriate as long as no inconsistency is caused in the content of a process. In each embodiment below, the same parts are denoted with the same reference numerals and redundant description will be omitted.

### Embodiment

### 1. Example of Information Processing

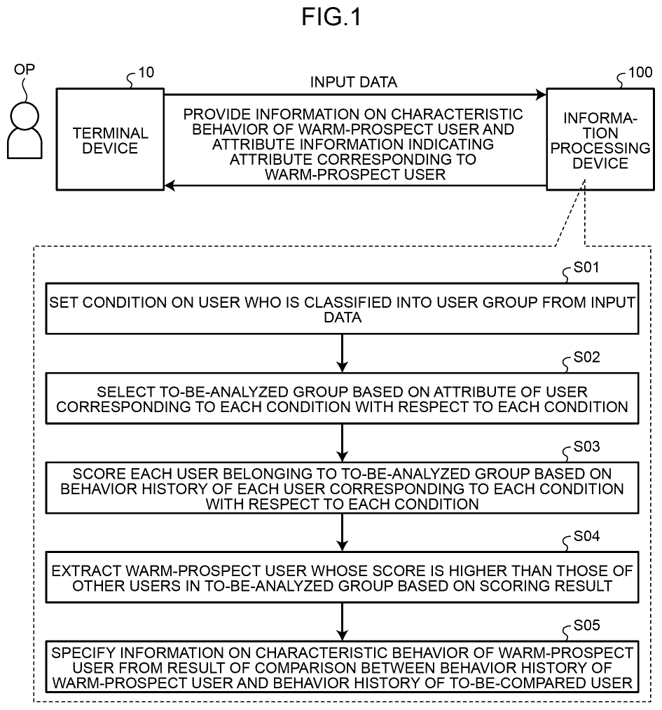

An example of information processing according to the embodiment will be described below with reference to the accompanying drawings. FIG. 1 is a diagram for describing the example of the information processing according to the embodiment.

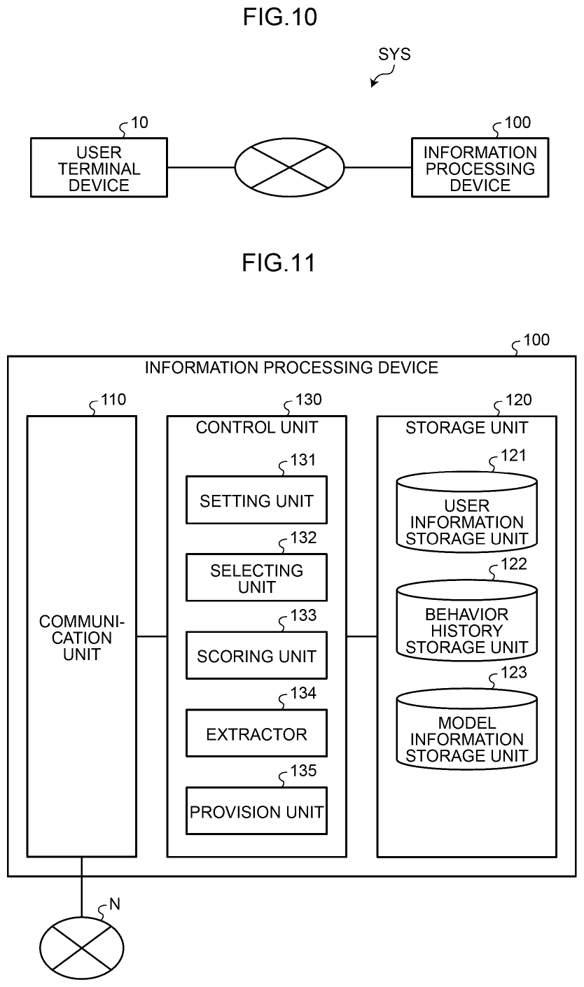

The information processing according to the embodiment is realized by an information processing system SYS (for example, refer to FIG. 10) including a terminal device 10 illustrated in FIG. 1 and an information processing device 100 illustrated in FIG. 1. The terminal device 10 and the information processing device 100 are able to communicate with another device via a network N.

As illustrated in FIG. 1, the terminal device 10 transmits input data of an operator OP to the information processing device 100. The operator OP, for example, inputs a URL and a prompt for determining recipients (targets) of delivery of content, such as a given advertisement, as a user interface to the terminal device 10 via a given tool that is displayed on the terminal device 10.

On receiving the input data that is input by the operator OP from the terminal device 10, the information processing device 100 sets conditions for users who are classified into a user group (step S01). Assuming that a user group is generated from the input data, the conditions for users is information that can be an audience category for categorizing each user. By inputting the input data to generative artificial intelligence (AI), the information processing device 100 is able to set information that is output from the generative AI as the conditions for users. The information processing device 100 is able to use, as the generative AI, text generative AI that is a language model enabling generation of text using natural language processing.

The information processing device 100 selects a to-be-analyzed group based on an attribute of a user corresponding to each condition with respect to each condition that is set on the user (step S02). For example, using the generative AI, the information processing device 100 is able to acquire an attribute of a user corresponding to each condition by converting each of the conditions into any one set of attribute information indicating an attribute of service users of an online service and select a to-be-analyzed group based on the acquired attribute.

The information processing device 100 scores each user who belongs to the to-be-analyzed group based on a behavior history of each user corresponding to each condition with respect to each condition (step S03). For example, using the generative AI, the information processing device 100 is able to acquire information on a search query by which each user corresponding to each condition is likely to make a search and score each user based on the acquired information on the search query.

Based on the result of the scoring, the information processing device 100 extracts a warm-prospect user whose score is higher than those of other users in the to-be-analyzed group (step S04).

The information processing device 100 selects a to-be-compared user who is to be compared with the warm-prospect user from the to-be-analyzed group and specifies information on a characteristic behavior of the warm-prospect user from the result of comparison between a behavior history of the warm-prospect user and a behavior history of the to-be-compared user (step S05).

The information processing device 100 transmits the specified information on the characteristic behavior of the warm-prospect user and attribute information indicating an attribute corresponding to the warm-prospect user to the terminal device 10 that the operator OP uses and thus provides the attribute information to the operator OP.

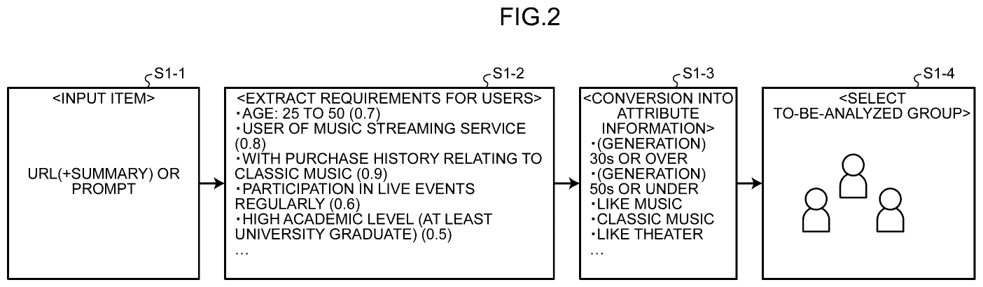

Using FIGS. 2 to 8, an overview of information processing according to the embodiment will be described specifically below. FIGS. 2 to 8 are diagrams for specifically describing the overview of the information processing according to the embodiment.

As illustrated in FIG. 2, the operator OP specifies, as input data, a URL (+summary) corresponding to a web page, such as a product presentation page or a review page, with information on a product to be advertised or a prompt for specifying a user to which an advertisement is delivered (step S1-1).

The summary that is input together with the URL that is specified as the input data is information that is a summary of the content of the web page corresponding to the URL. The prompt is instruction information for making an instruction to extract conditions for users who are classified into a user group to the generative AI from the input data.

The information processing device 100 inputs the URL or the prompt that is specified by the operator OP as the input data to the generative AI and thus executes extraction of the conditions for users (step S1-2).

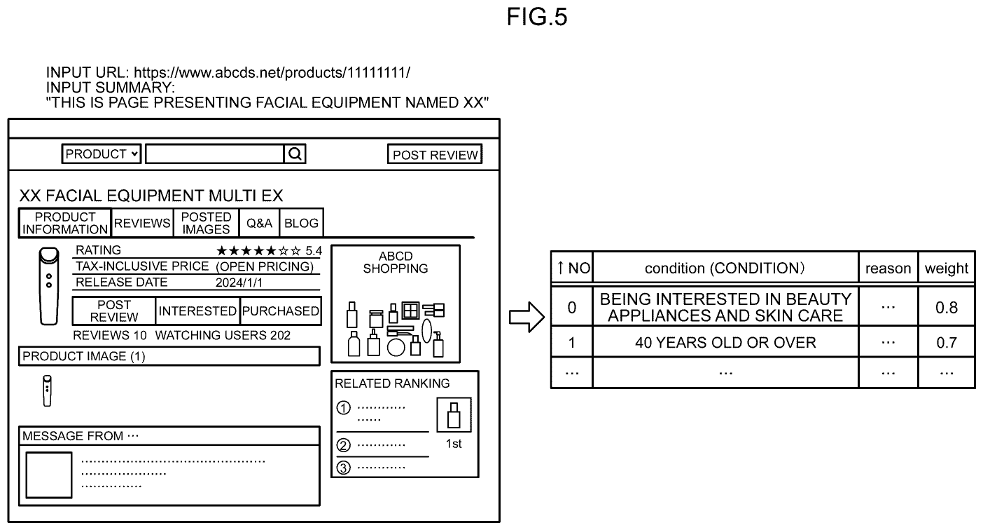

A process in the case where the URL is acquired as the input data will be described specifically. The information processing device 100 inputs the URL that is acquired as the input data and the summary that is acquired together with the URL to the generative AI. The generative AI analyzes the content of the web page corresponding to the URL along the view described in the summary, extracts the conditions for users who are interested in a product and a service on the web page (for example, users who are likely to purchase the product and the service) entirely and without redundancy, and outputs the extracted conditions. The generative AI outputs, with respect to each of the conditions, weighting indicating whether the extracted condition contributes to a typical user image of a user who is interested in the product and the service on the webpage. The information processing device 100 acquires the conditions for users that are output from the generative AI. FIG. 5 illustrates an example of the conditions for users that are extracted from the URL according to the embodiment.

As illustrated in FIG. 5, in the case where the product on the web page corresponding to the URL is “facial equipment”, the generative AI analyzes the content of the web page according to the view of the summary that is input: “This is a page presenting facial equipment named XX.” The generative AI extracts a plurality of conditions, such as “a person who is interested in beauty appliances and skin care” and “a person who is at or above 40 years old”, as the conditions for users who are interested in “facial equipment”.

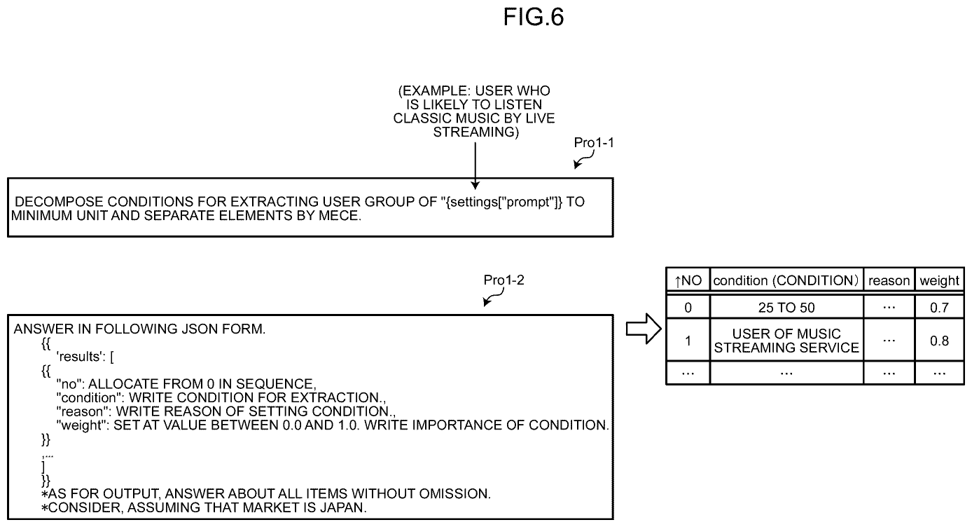

A process in the case where the prompt is acquired as the input data will be described specifically. FIG. 6 illustrates an example of the prompt according to the embodiment. For example, the information processing device 100 inputs a prompt Pro1-1 and a prompt Pro1-2 illustrated in FIG. 6 to the generative AI.

For example, in the case where “user who is likely to listen to classic music by live streaming” is set in the prompt Pro1-1 illustrated in FIG. 6, the generative AI extracts a plurality of conditions, such as “age: 25 to 50” and “user of a music streaming service” (refer to FIG. 2), entirely and without redundancy as conditions for users who are likely to listen to classic music by live streaming from an existing referable database according to the prompt Pro1-1 and the prompt Pro1-2 and outputs the extracted conditions.

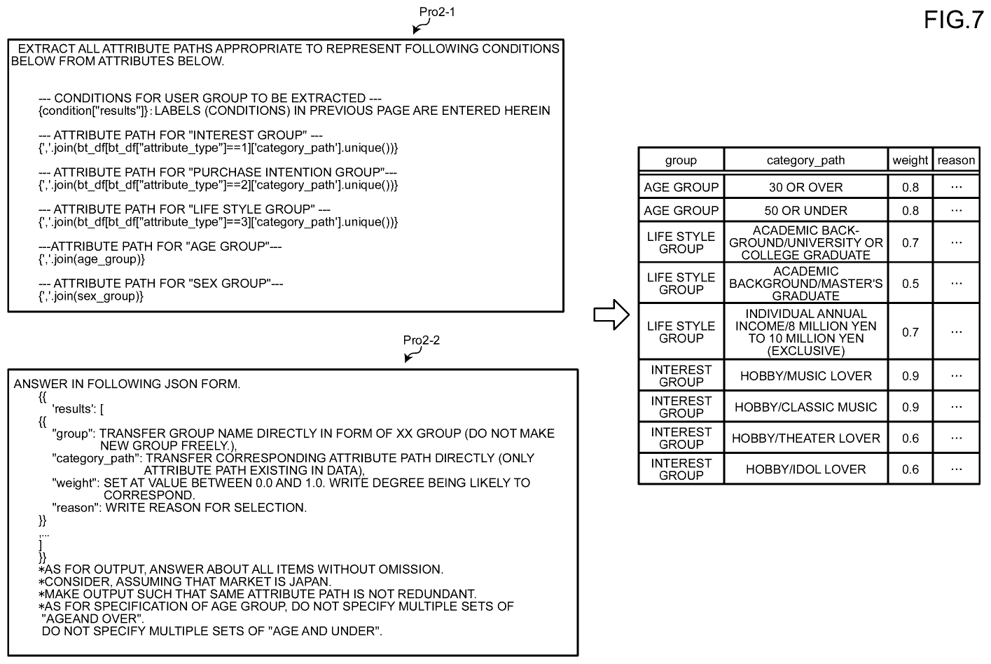

Back to FIG. 2, on acquiring the conditions for users, the information processing device 100 inputs the acquired conditions and the prompts to the generative AI. According to the input prompts, the generative AI converts each of the conditions to any one of sets of attribute information indicating an attribute of service users of the online service that the information processing device 100 has (step S1-3). The attributes of service users include a demographic attribute, such as the age, gender, and an annual income, and a psychographic attribute, such as an interest, a purchase intention, and a life style. FIG. 7 illustrates an example of the prompts and the attribute information into which the conversion is made by the generative AI according to the embodiment.

The information processing device 100 inputs the prompt Pro2-1 and the prompt Pro2-2 like those illustrated in FIG. 7 to the generative AI. The generative AI converts the conditions for users that are set in the prompt Pro2-1 into the attribute information contained in a given attribute group, such as an age group or a life style, according to a form that is specified by the prompt Pro2-2. For example, according to FIG. 7, the generative AI converts the condition for users of “age: 25 to 50” illustrated in FIG. 2 into corresponding attribute information of “30 or over” and “50 or under” of the age group.

Back to FIG. 2, after converting the conditions for users into attribute information, the information processing device 100 selects a to-be-analyzed group using the attribute information obtained by conversion (step S1-4). The information processing device 100 is able to generate sets of attribute information and a freely-selected combination of sets of attribute information and select a to-be-analyzed group from the generated combination. For example, the information processing device 100 generates a combination of a condition of the age and sex and any one of psychographic attributes, such as an interest, a purchase intention, and a life style, from the sets of attribute information and selects a to-be-analyzed group from the generated combination of the attributes.

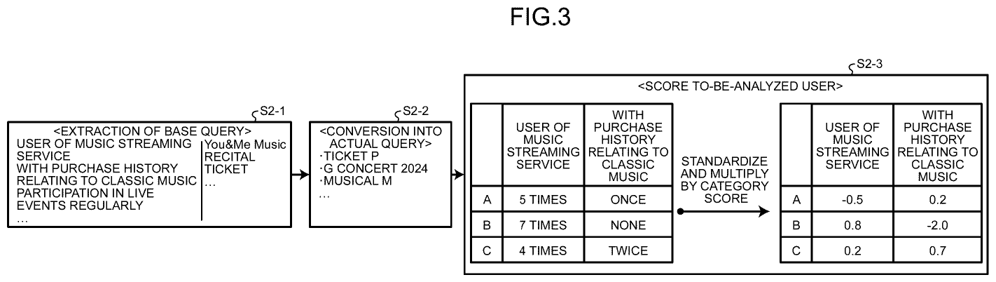

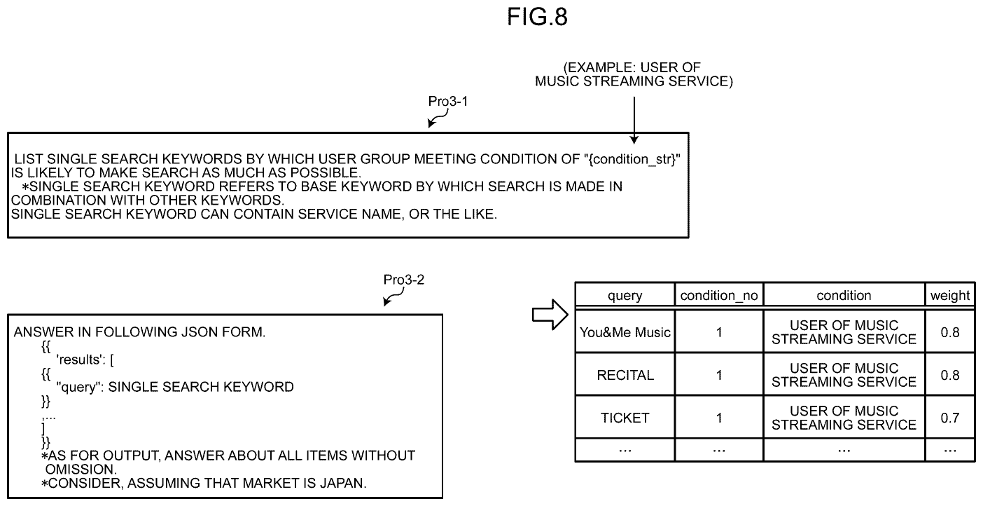

After selecting the to-be-analyzed group, as illustrated in FIG. 3, the information processing device 100 executes extraction of queries serving as bases (referred to as “base query” as appropriate below) (step S2-1). Specifically, using the generative AI, the information processing device 100 acquires queries by which users who are likely to meet the conditions for users are likely to make a search. FIG. 8 illustrates an example of the prompts and the base queries that are extracted by the generative AI according to the embodiment.

The information processing device 100 inputs a prompt Pro3-1 and a prompt Pro3-2 illustrated in FIG. 8 to the generative AI. The generative AI lists queries by which each user who is likely to meet the condition for users that is set in the prompt Pro3-1 is likely to make a search in the form specified by the prompt Pro3-2. In the case where “user of music streaming service” is set as a condition for users in the prompt Pro3-1 illustrated in FIG. 8, the generative AI lists “You&Me Music”, “recital”, “ticket”, etc., as search keywords by which a user who meets a user of a music streaming service is likely to make a search from the referable database.

Back to FIG. 3, after extraction of the base queries, the information processing device 100 converts the extracted base queries into actual queries with a record of being used by service users of the on-line service (“actual queries” below as appropriate) (step S2-2). Specifically, the information processing device 100 refers to a search history of service users of the online service and extracts actual queries that partly match the base queries, thereby trying to convert the base queries. By refining the queries by which searching users exceeding a given number make a search in the extracted actual queries, the information processing device 100 excludes noise.

After converting the base queries into the actual queries, the information processing device 100 executes scoring the to-be-analyzed user (step S2-3). Specifically, the information processing device 100 refers to a search record of each of the to-be-analyzed users and adds “1” to the score corresponding to the condition with respect to the to-be-analyzed user according to the number of actual queries with a search record in a given period in the past. Next, the information processing device 100 standardizes the score of each of the to-be-analyzed users with respect to each condition and multiplies each of the conditions by a corresponding weight. The information processing device 100 derives a total obtained by adding up scores corresponding to the respective conditions with respect to each to-be-analyzed user as a score of the to-be-analyzed user.

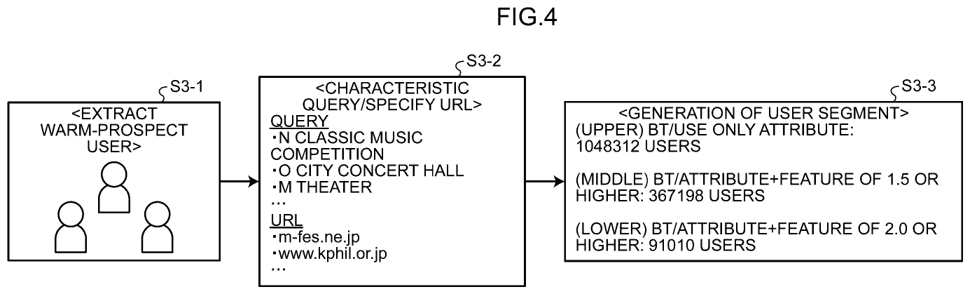

After scoring the to-be-analyzed users, as illustrated in FIG. 4, the information processing device 100 extracts a warm-prospect user from the to-be-analyzed users (step S3-1). Specifically, the information processing device 100 extracts a user whose score is higher than those of other users (for example, a given number of users with higher scores) in the to-be-analyzed group as a warm-prospect user. The information processing device 100 assumes that the extracted warm-prospect user as a to-be-analyzed user who meets the conditions.

After extracting the warm-prospect user, the information processing device 100 specifies a query by which a characteristic search is made by the warm-prospect user and a URL that is visited by the warm-prospect user (step S3-2).

Specifically, the information processing device 100 selects a to-be-compared user who is to be compared with the warm-prospect user from the to-be-analyzed group. For example, the information processing device 100 selects a user that matches the warm-prospect user in attribute information and the number of times of searching as the to-be-compared user from the to-be-analyzed users. Next, the information processing device 100 compares a search history and a browsing history of the warm-prospect user and a search history and a browsing history of the to-be-compared user mutually. The information processing device 100 then specifies a query that is more searched by the warm-prospect user than the to-be-compared user and a URL that is more visited by the warm-prospect user than the to-be-compared user from the result of comparison between the search history and the browsing history of the warm-prospect user and the search history and the browsing history of the to-be-compared user.

The information processing device 100 calculates a feature of the query and the URL that are specified. For example, the information processing device 100 divides a ratio of search with the query by the warm-prospect user by a ratio of search with the query by the to-be-compared user and calculates, as the feature, a value indicating a degree in which a search tends to be made with the query more by the warm-prospect user than by the to-be-compared user.

For example, when the ratio of search by the warm-prospect user is “10%” and the ratio of search by the to-be-compared user is “1%”, the feature is “10”. In the same manner, the information processing device 100 is able to calculate a feature of the URL.

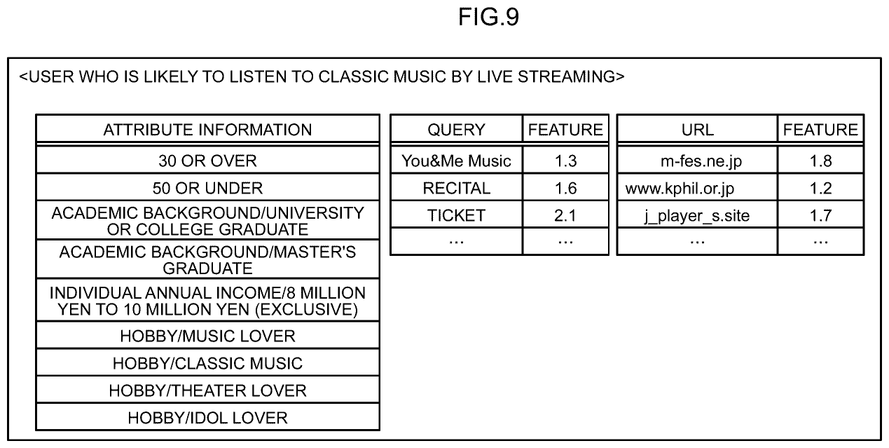

The information processing device 100 transmits information on the characteristic query and the URL that are specified and the attribute information indicating the attribute to the terminal device 10 and thus provides the information to the operator OP. FIG. 9 is a diagram illustrating an example of suggestion information according to the embodiment. On receiving a prompt in which “user who is likely to listen to classic music by live streaming” is set from the operator OP, the information processing device 100 provides suggestion information like that exemplified in FIG. 9 as “user who is likely to listen to classic music by live streaming”.

As described above, the information processing device 100 according to the embodiment is able to provide the operator OP with the suggestion information for specifying a user corresponding to the URL and the prompt according to the URL and the prompt that are specified by the operator OP. Accordingly, it is possible to assist in selecting a recipient of content, such as an advertisement.

The operator OP specifies the URL and the prompt and thus generates a user segment by a freely-selected method using information on the characteristic query and the URL that is received from the information processing device 100 (step S3-3). For example, with reference to the suggestion information exemplified in FIG. 9, the operator OP is able to set conditions for extracting a segment and generate a user segment corresponding to each of the extraction conditions. For example, the operator OP is able to extract a user segment in an UPPER layer in which user corresponding to specific attribute information is extracted from all service users, a user segment in a MIDDLE layer into which a user who corresponds to specific attribute information and has a search record of a query with a feature of 1.5 or higher and a browsing record of a web page corresponding to a URL with a feature of 1.5 or higher is classified among all service users, and a user segment in a LOWER layer into which a user who corresponds to specific attribute information and has a search record of a query with a feature of 2.0 or higher and a browsing record of a web page corresponding to a URL with a feature of 2.0 or higher is classified among all service users.

### 2. System Configuration

Using FIG. 10, a configuration of the information processing system SYS according to the embodiment will be described in detail below. FIG. 10 is a diagram illustrating an example of a system configuration of the information processing system SYS according to the embodiment.

As illustrated in FIG. 10, the information processing system SYS according to the embodiment includes the terminal deice 10 and the information processing device 100. Note that FIG. 10 only illustrates an example of the configuration of the information processing system SYS according to the embodiment, and a plurality of the terminal devices 10 may be included.

The terminal device 10 and the information processing device 100 may be connected in a wireless or wired manner via the network N. Each of the terminal device 10 and the information processing device 100 is able to communicate with another device mutually via the network N.

The network N includes a mobile communication network, such as a WAN (Wide Area Network), a LTE (Long Term Evolution), 4G (4th Generation), or 5G (5th Generation: 5th generation mobile communication system).

The terminal device 10 is connected to the network N by near field communication, such as Bluetooth (trademark) or a wireless LAN (Local Area Network), and is able to communicate with another device, such as the information processing device 100, via the network N.

The terminal device 10 is used by the operator OP. The operator OP may be an advertisement delivery operator that provides advertisement delivery to an advertiser who submits advertisement information to the information processing device 100 and makes a request to deliver an advertisement or may be an advertiser. The terminal device 10 may be, for example, a laptop personal computer (PC), a desktop PC, a smartphone, or a tablet PC.

The operator OP operates the terminal device 10, access the information processing device 100 by an application programming interface (API) that is provided by a service operator that manages the information processing device 100, and inputs a URL and a prompt for determining a recipient (target) of delivery of content, such as a given advertisement, via a given tool that is displayed as a user interface on the terminal device 10. The given tool may be a dedicated application program (referred to as a “dedicated application” below) with various types of functions for setting a URL and a prompt or a given website that can be displayed by a web browser.

The terminal device 10, for example is able to display content that is provided from the information processing device 100 by a dedicated application or a web browser. On receiving control information that realizes a process of displaying information from the information processing device 100, the terminal device 10 realizes the display process according to control information.

The control information, for example, is written in a script language, such as JavaScript (trademark), a style sheet language, such as CSS (Cascading Style Sheets), a programming language, such as JAVA (trademark), or a markup language, such as HTML (Hypertext Markup Language). A given application that is delivered by the information processing device 100, or the like, itself may be regarded as the control information.

The information processing device 100 may be operated and managed by an advertisement delivery operator to which an advertiser provides suggestion information on delivery of an advertisement. The advertisement delivery operator may be a service operator what provides various types of online services to service users.

The various types of online services can include, for example, a news site, a search service, a travel information provision service, a SNS (social networking service), an electronic commerce transaction service, an electronic transaction service, an online game, an online banking service, an online trading service, an accommodation reservation service, a ticket reservation service, a video streaming service, a music streaming service, a map information service, a route search service, a route guide service, a route information service, an operational information service, a weather information service, and an inquiry service. Note that the various types of online services may include an API (Application Programming Interface) service corresponding to various types of applications.

The information processing device 100 is a server device typically, and the information processing device 100 may be realized by a main frame, a work station, and the like. When the information processing device 100 is realized by a server device, the information processing device 100 may be realized by a single server device or may be realized by a cloud system that a plurality of server devices and a plurality of storage devices operate cooperatively.

### 3. Device Configuration

Using FIG. 11, an example of a functional configuration of the information processing device 100 that the information system SYS according to the embodiment includes will be described. FIG. 11 is a diagram illustrating an example of a configuration of the information processing device 100 according to the embodiment. As illustrated in FIG. 11, the information processing device 100 includes a communication unit 110, a storage unit 120, and a control unit 130.

### Communication Unit 110

The communication unit 110, for example, is realized by a communication module and a network interface card (NIC), or the like. The communication unit 110 is connected to the network N in a wired or wireless manner. The information processing device 100 transmits and receives information to and from another device, such as the terminal device 10, via the given network N.

### Storage Unit 120

The storage unit 120, for example, stores a program and data that are used for control and arithmetic operations by the control unit 130. For example, the storage unit 120 is realized by a semiconductor memory device, such as a random access memory (RAM) or a flash memory, or a storage device, such as a hard disk or an optical disk. For example, the storage unit 120 includes a user information storage unit 121, a behavior history storage unit 122, and a model information storage unit 123. Note that the storage unit 120 is not particularly limited to the example illustrated in FIG. 11, and the storage unit 120 may store data, and the like, necessary to execute the information processing according to the embodiment as appropriate.

### User Information Storage Unit 121

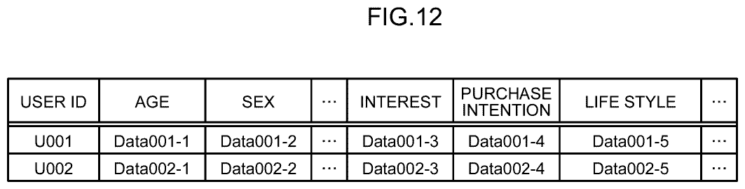

The user information storage unit 121 stores user information on service users of various types of online services. FIG. 12 is a diagram illustrating an overview of the user information that is stored in the user information storage unit 121 according to the embodiment.

As illustrated in FIG. 12, the user information that is stored in the user information storage unit 121 has a plurality of items, such as an item of “user ID”, an item of “age”, and item of “sex”, ad item of “interest”, an item of “purchase intention”, and an item of “life style”. These items that the user information has are associated with each other.

In the item of “user ID”, identification information for identifying the service users of the various types of online services is stored. In the item of “age”, information presenting the age of the service users is stored. In the item of “sex, information presenting sex of the service users is stored.

In the item of “interest”, information presenting interests of the service users is stored. In the item of “purchase intension”, information presenting purchase intentions of the service users is stored. In the item of “life style”, information presenting life styles of the service users is stored.

The user information that is stored in the user information storage unit 121 may include, in addition to the information illustrated in FIG. 12, information, such as academic backgrounds, occupations, annual incomes, and habitats that are demographic attributes of the service users.

### Behavior History Storage Unit 122

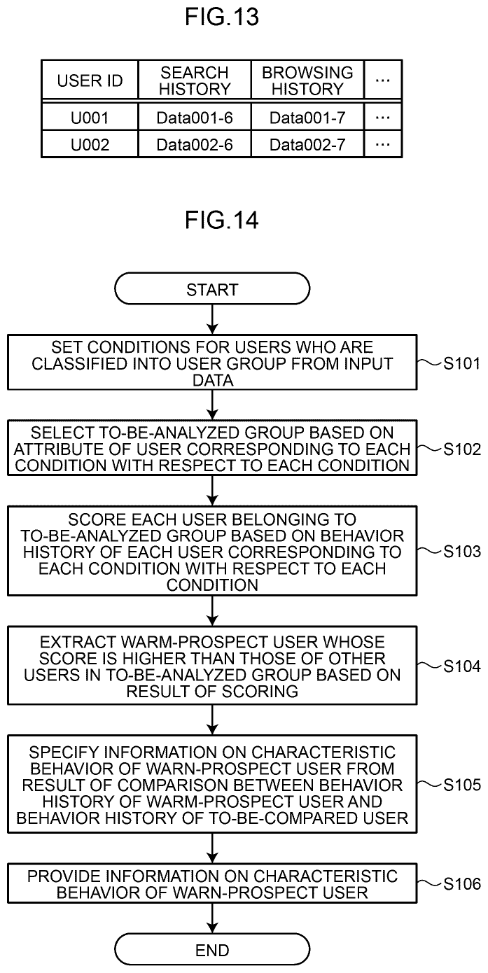

The behavior history storage unit 122 stores a behavior history that is information presenting various types of behaviors of the service users of the various types of online services. FIG. 13 is a diagram illustrating an overview of the behavior history that is stored in the behavior history storage unit 122 according to the embodiment.

As illustrated in FIG. 13, the behavior history that is stored in the behavior history storage unit 122 has a plurality of items, such as an item of “user ID”, an item of “search history”, and an item of “browsing history”. These items the behavior history has are associated with each other.

In the item of “user ID”, identification information for identifying the service users of the various types of online services is stored. In the item of search history”, information on queries (search keywords) used by the service users for searching in the various types of online services and search dates is stored. In the item of “browsing history”, information on URLS of websites browsed by the services users in the various types of online services and browsing dates is stored.

### Model Information Storage Unit 123

In the model information storage unit 123, information on a model that executes the information processing according to the embodiment is stored. In the information on the model that is stored in the model information storage unit 123, information on the generative AI that is trained to generate an answer to a question that is input and that is used to extract a condition for users (for example, refer to FIG. 5 and FIG. 6), convert each condition into attribute information (for example, refer to FIG. 7), and extract a base query by which a user corresponding to each condition is likely to make a search (for example, refer to FIG. 8) is stored.

The generative AI, for example, is realized by AI (Artificial Intelligence), such as GPT (Generative Pre-trained Transformer). GPT is text generative AI and is a language model enabling generation of text using natural language processing.

### Control Unit 130

The control unit 130 is a controller and, for example, is realized in a way that a central processing unit (CPU), a micro processing unit (MPU), or the like, executes various types of programs (an example of the information processing program) that are stored in a storage device in the information processing device 100 using a RAM as a work area.

The control unit 130 may be realized by, for example, an integrated circuit, such as an application specific integrated circuit (ASIC), a field programmable gate array (FPGA), or a general purpose graphic processing unit (GPGPU).

As illustrated in FIG. 11, the control unit 130 includes a setting unit 131, a selecting unit 132, a scoring unit 133, an extractor 134, and a provision unit 135 and these units realize or execute functions and effects of the image processing described below.

The control unit 130 may have multiple internal configurations that are divided according to the unit of processing in which the functions and effects of the image processing described below are realized or executed. The control unit 130 is not limited to the configuration illustrated in FIG. 11. The control unit 130 may have another configuration as long as the configuration enables the following information processing and may have a functional unit other than those illustrated in FIG. 11.

### Setting Unit 131

The setting unit 131 sets a condition for users who are classified into a user group from input data that is input by the operator. Specifically, the setting unit 131 inputs a URL or a prompt that is specified by the operator OP as input data to the generative AI and thus executes extraction of a condition for users.

For example, on receiving a URL and summary information obtained by summarizing information on a website corresponding to the URL from the operator OP, the setting unit 131 inputs the URL and the summary information to the first generative AI that is trained to generate an answer to a question that is input and thus sets, for a condition, information that is output from the first generative AI (for example, refer to FIG. 5).

For example, on receiving a prompt as input data from the operator OP, the setting unit 131 inputs information on instruction text making an instruction to generate a condition for each user (to-be-analyzed user) belonging to the to-be-analyzed group to the first generative AI that is trained to generate an answer to a question that is input and thus sets information (for example, refer to FIG. 6) that is output from the first generative AI for a condition.

### Selecting Unit 132

The selecting unit 132 selects a to-be-analyzed group based on attributes of users corresponding to each condition with respect to each condition that is set by the setting unit 131.

Specifically, the selecting unit 132 inputs an instruction text making an instruction to convert the condition that is set by the setting unit 131 into any one set of attribute information indicating an attribute of service users of an online service to a second generative AI that is trained to generate an answer to a question that is input, thus acquires attribute information (for example, refer to FIG. 7) that is output from the second generative AI, and selects a to-be-analyzed group based on the acquired attribute information.

For example, the selecting unit 132 is able to generate a to-be-analyzed group using attribute information and a freely selected combination of sets of attribute information. For example, the information processing device 100 generates a combination of a condition of the age and sex and any one of psychographic attributes, such as an interest, a purchase intention, and a life style, from the sets of attribute information and selects a to-be-analyzed group from the generated combination of the attributes.

### Scoring Unit 133

The scoring unit 133 scores each user who meets a condition based on a behavior history of each user corresponding to each condition with respect to each condition. Specifically, the scoring unit 133 inputs instruction text making an instruction to list base queries that are queries by which each user who meets the condition is likely to make a search to third generative AI that is trained to generate an answer to a question that is input, thus acquires information on the base queries that is output from the third generative AI, and scores each user meeting the condition based on the acquired information on the base queries.

For example, after extraction of the base queries, the scoring unit 133 converts the extracted base queries into actual queries with a record of being used by service users of the on-line service (“actual queries” below as appropriate). Specifically, the scoring unit 133 refers to a search history of service users of the online service and extracts actual queries that partly match the base queries, thereby trying to convert the base queries. By refining the queries by which searching users exceeding a given number make a search in the extracted actual queries, the scoring unit 133 excludes noise.

After converting the base queries into the actual queries, the scoring unit 133 executes scoring the to-be-analyzed user. Specifically, the scoring unit 133 refers to a search record of each of the to-be-analyzed users and adds “1” to the score corresponding to the condition with respect to the to-be-analyzed user according to the number of actual queries with a search record in a given period in the past. Next, the scoring unit 133 standardizes the score of the to-be-analyzed users with respect to each condition and multiplies each of the conditions by a corresponding weight. The scoring unit 133 derives a total obtained by adding up scores corresponding to the respective conditions with respect to each to-be-analyzed user as a score of the to-be-analyzed user.

### Extractor 134

Based on a result of scoring by the scoring unit 133, the extractor 134 extracts a warm-prospect user whose score is higher than those of other users in the to-be-analyzed group. Specifically, the extractor 134 extracts a user whose score is higher than those of other users (for example, a given number of users with higher scores) in the to-be-analyzed group as a warm-prospect user. The extractor 134 assumes that the extracted warm-prospect user as a to-be-analyzed user who meets the conditions.

### Provision Unit 135

The provision unit 135 selects a to-be-compared user who is to be compared with the warm-prospect user from the to-be-analyzed group, specifies information on a characteristic behavior of the warm-prospect user from a result of comparison between a behavior history of the warm-prospect user and a behavior history of the to-be-compared user, transmits the specified information on the characteristic behavior and attribute information indicating an attribute corresponding to the warm-prospect user to the terminal device 10 that the operator OP uses, and thus provides the attribute information to the operator OP.

Specifically, the provision unit 135 selects a user that matches the warm-prospect user in attribute information (a demographic attribute and a psychographic attribute) and the number of times of searching (then number of times the search keyword is input in the online service) as the to-be-compared user from the to-be-analyzed users. Next, the provision unit 135 compares a search history and a browsing history of the warm-prospect user and a search history and a browsing history of the to-be-compared user mutually. The provision unit 135 then specifies a query that is more searched by the warm-prospect user than the to-be-compared user and a URL that is more visited by the warm-prospect user than the to-be-compared user from the result of comparison between the search history and the browsing history of the warm-prospect user and the search history and the browsing history of the to-be-compared user.

The provision Unit 135 calculates a feature of the query and the URL that are specified. For example, the provision unit 135 divides a ratio of search with the query by the warm-prospect user by a ratio of search with the query by the to-be-compared user and calculates, as the feature, a value indicating a degree in which a search tends to be made with the query more by the warm-prospect user than by the to-be-compared user. For example, when the ratio of search by the warm-prospect user is “10%” and the ratio of search by the to-be-compared user is “1%”, the feature is “10”. In the same manner, the provision unit 135 is able to calculate a feature of the URL.

After calculation of the features, the provision unit 135 transmits information on the specified characteristic query and URL and attribute information indicating the attribute corresponding to the warm-prospect user to the terminal device 10 via the communication unit 110 and thus provides the information to the operator OP.

### Procedure According to Embodiment

A procedure of the information processing that the information processing device 100 according to the embodiment executes will be described below. FIG. 14 is a flowchart illustrating an example of the procedure of the information processing that is executed by the information processing device 100 according to the embodiment. The procedure illustrated in FIG. 14 is executed by the control unit 130 of the information processing device 100. The procedure illustrated in FIG. 14 is executed repeatedly while the information processing device 100 is in operation.

As illustrated in FIG. 14, the setting unit 131 sets conditions for users who are classified into a user group from input data that is input by an operator (step S101).

The selecting unit 132 selects a to-be-analyzed group based on an attribute of a user corresponding to each condition with respect to each condition (step S102).

The scoring unit 133 scores each user who meets a condition based on a behavior history of each user corresponding to each condition with respect to each condition (step S103).

Based on a result of scoring by the scoring unit 133, the extractor 134 extracts a warm-prospect user whose score is higher than those of other users in the to-be-analyzed group (step S104).

The provision unit 135 selects a to-be-compared user who is to be compared with the warm-prospect user from the to-be-analyzed group, specifies information on a characteristic behavior of the warm-prospect user from a result of comparison between behavior information on the warm-prospect user and behavior information on the to-be-compared user, and transmits the specified information on the characteristic behavior and attribute information representing an attribute corresponding to the warm-prospect user to the terminal device 10 that the operator uses, thus provides the specified information and the attribute information to the operator (step S105), and ends the procedure illustrated in FIG. 11.

### 5. Hardware Configuration

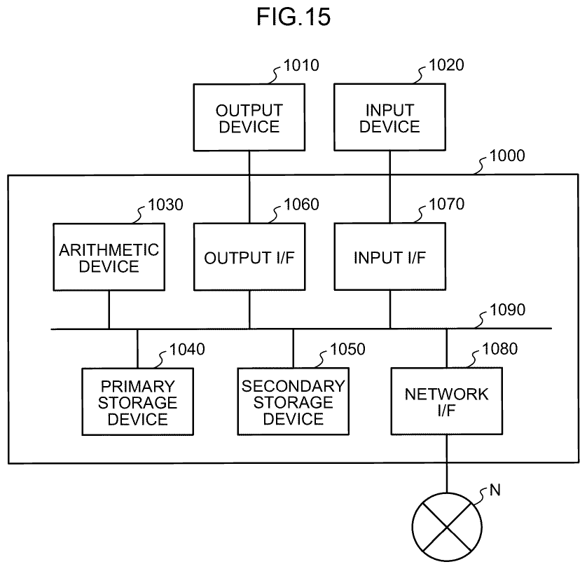

The information processing device 100 according to the above-described embodiment and each modification is realized by, for example, a computer 1000 having a configuration like that illustrated in FIG. 15. FIG. 15 is a hardware configuration diagram illustrating an example of a computer that realizes the functions of the information processing device 100 according to the embodiment.

The computer 1000 has a mode where the computer 1000 is connected to an output device 1010 and an input device 1020 and an arithmetic device 1030, a primary storage device 1040, a secondary storage device 1050, an output interface (IF) 1060, an input IF 1070, and a network IF 1080 are connected via a bus 1090.

The arithmetic device 1030 operates according to programs that are stored in the primary storage device 1040 and the secondary storage device 1050 and a program that is read from the input device 1020, or the like, and executes various types of processing. The primary storage device 1040 is a memory device that primarily stores data that the arithmetic device 1030 uses for various types of arithmetic operations, such as a RAM. The secondary storage device 1050 is a storage device in which data that the arithmetic device 1030 uses for various types of arithmetic operations and in which various types of databases are registered, and is realized by a read only memory (ROM), a HDD, a flash memory, or the like.

The output IF 1060 is an interface for transmitting information to be output to the output device 1010 that outputs various types of information, such as a monitor or a printer and is realized by, for example, a connector according to a standard, such as universal serial bus (USB) or digital visual interface (DVI), or high definition multimedia interface (HDMI) (trademark). The input IF 1070 is an interface for receiving information from various types of the input devices 1020, such as a mouse, a keyboard and a scanner, and is realized by, for example a USB.

Note that the input device 1020 may be, for example, a device that reads information from an optical recording medium, such as a compact disc (CD), a digital versatile disc (DVD) or a phase change rewritable disk (PD), a magneto-optical recording medium, such as a magneto-optical disk (MO), a tape medium, a magnetic recording medium, or a semiconductor memory. The input device 1020 may be an external recording medium, such as a USB memory.

The network IF 1080 receives data from another device via the network N and transmits the data to the arithmetic device 1030 and transmits data that is generated by the arithmetic device 1030 to another device via the network N. The arithmetic device 1030 controls the output device 1010 and the input device 1020 via the output IF 1060 ad the input IF 1070. For example, the arithmetic device 1030 loads programs from the input device 1020 and the secondary storage device 1050 onto the primary storage device 1040 and executes the loaded programs.

For example, when the computer 1000 functions as the information processing device 100 according to the embodiment, the arithmetic device 1030 of the computer 1000 executes the program (for example, an information processing program) that is loaded into the primary storage device 1040, thereby implementing the same function as that of the control unit 130. In other words, in cooperation with the program (for example, the information processing program) that is loaded into the primary storage device 1040, the arithmetic device 1030 realizes a process performed by the information processing device 100 according to the embodiment.

### 6. Remarks

In the above-described embodiment, the information processing device 100 may generate suggestion segment information for suggesting a user segment using suggestion information and provides the generated suggestion segment information to the operator OP. For example, the provision unit 135 generates, for example, each of a user segment in an UPPER layer and user segments in a MIDDLE layer and a LOWER layer according to a segment extraction condition that is set previously. For example, the segment condition may be redundant conditions such that users of subjects are refined from the UPPER layer to the LOWER layer. The segment extraction condition may be received from the operator OP or may be a default setting in the system. Only specific attribute information may be set, and the provision unit 135 provides information on the generated user segment as suggestion segment information to the terminal device 10 via the communication unit 110 and thus provides the operator OP with the information.

Among the processes described in the above-described embodiment, all or part of processes that are described as being performed automatically may be performed manually or all or part of processes that are described as being performed manually may be performed automatically by a known method. Furthermore, the procedures, specific names, and information including various types of data and parameters that are presented in the description above and the drawings are changeable optionally except as otherwise provided.

Each of the components of each of the devices illustrated in the drawings is of functional concepts and need not necessarily be configured physically as illustrated in the drawings. In other words, specific modes of distribution and integration of each device are not limited to those illustrated in the drawings, and all or part of the devices may be configured by being distributed or integrated functionally or physically in any unit and according to various types of load and usage.

It is also possible to combine the above-described embodiments as appropriate as long as no inconsistency is caused in the content of the processes.

The embodiment of the present application has been described in detail according to some drawings and the embodiment is exemplary only and it is possible to carry out the present invention, starting with the mode described in the disclosure part, in other modes where various modifications and improvements are made based on the knowledge of those skilled in the art.

The above-described “section, module or unit” may be read as “means”, “circuitry” or the like. For example, a control unit may be read as a control means or control circuitry.

### 7. Effect

The information processing device includes the setting unit 131, the selecting unit 132, the scoring unit 133, the extractor 134, and the provision unit 135. The setting unit 131 sets a condition for a user who is classified into a user group from input data that is input by the operator OP. The selecting unit 132 selects a to-be-analyzed group based on an attribute of a user corresponding to each condition with respect to each the condition. The scoring unit 133 scores each user who meets the condition based on a behavior history of each user corresponding to each condition with respect to each the condition. The extractor 134 extracts a warm-prospect user whose score is higher than those of other users in the to-be-analyzed group based on a result of scoring performed by the scoring unit 133. The provision unit 135 selects a to-be-compared user who is to be compared with the warm-prospect user from the to-be-analyzed group, specifies information on a characteristic behavior of the warm-prospect user from a result of comparison between behavior information on the warm-prospect user and behavior information on the to-be-compared user, transmits information on the specified characteristic behavior and attribute information indicating the attribute corresponding to the warm-prospect user to a terminal device 10 that the operator OP uses, and thus provides the specified information and the attribute information to the operator OP.

The setting unit 131 sets, for the condition, information that is output from generative AI that is trained to generate an answer to a question that is input by inputting a URL and summary information obtained by summarizing information on a website corresponding to the URL as the input data to the generative AI.

The setting unit 131 sets, for the condition, information that is output from generative AI that is trained to generate an answer to a question that is input by inputting information on instruction text that makes an instruction to generate a condition for each user who belongs to the to-be-analyzed group to the generative AI.

The selecting unit 132 acquires attribute information that is output from generative AI that is trained to generate an answer to a question that is input by inputting instruction text that makes an instruction to convert the condition to any one set of attribute information indicating an attribute of a service user of an online service to the generative AI and selects the to-be-analyzed group based on the acquired attribute information.

The scoring unit 133 acquires information on queries that is output from generative AI that is trained to generate an answer to a question that is input by inputting instruction text that makes an instruction to list queries by which each user corresponding to the to-be-analyzed group is likely to make a search to the generative AI and scores each user who belongs to the to-be-analyzed group based on the acquired information on the queries.

the provision unit 135 specifies a query by which a search is made more by the warm-prospect user than by the to-be-compared user and a URL that is visited more by the warm-prospect user than by the to-be-compared user from a result of comparison between a search history and a browsing history of the warm-prospect user and a search history and a browsing history of the to-be-compared user.

As described above, according to the URL and the prompt that are specified by the operator OP, the information processing device 100 according to the embodiment is able to provide suggestion information for specifying a user corresponding to the URL and the prompt according to the operator OP. Accordingly, it is possible to assist in selecting a recipient of delivery of content, such as an advertisement.

The process that is executed by each of the units described above and a combination of the processes executed by the units enable the above-described effect.

According to a mode of the embodiment, it is possible to assist selection of recipients of delivery of content, such as an advertisement.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a setting unit that sets a condition for a user who is classified into a user group from input data that is input by an operator;
a selecting unit that selects a to-be-analyzed group based on an attribute of a user corresponding to each condition with respect to each the condition;
a scoring unit that scores each user who meets the condition based on a behavior history of each user corresponding to each condition with respect to each the condition;
an extractor that extracts a warm-prospect user whose score is higher than those of other users in the to-be-analyzed group based on a result of scoring performed by the scoring unit; and
a provision unit that selects a to-be-compared user who is to be compared with the warm-prospect user from the to-be-analyzed group, specifies information on a characteristic behavior of the warm-prospect user from a result of comparison between behavior information on the warm-prospect user and behavior information on the to-be-compared user, transmits information on the specified characteristic behavior and attribute information indicating the attribute corresponding to the warm-prospect user to a terminal device that the operator uses, and thus provides the specified information and the attribute information on the operator.

2. The information processing device according to claim 1, wherein the setting unit sets, for the condition, information that is output from generative AI that is trained to generate an answer to a question that is input by inputting a URL and summary information obtained by summarizing information on a website corresponding to the URL as the input data to the generative AI.

3. The information processing device according to claim 1, wherein the setting unit sets, for the condition, information that is output from generative AI that is trained to generate an answer to a question that is input by inputting information on instruction text that makes an instruction to generate a condition for each user who belongs to the to-be-analyzed group to the generative AI.

4. The information processing device according to claim 1, wherein the selecting unit acquires attribute information that is output from generative AI that is trained to generate an answer to a question that is input by inputting instruction text that makes an instruction to convert the condition to any one set of attribute information indicating an attribute of a service user of an online service to the generative AI and selects the to-be-analyzed group based on the acquired attribute information.

5. The information processing device according to claim 4, wherein the scoring unit acquires information on queries that is output from generative AI that is trained to generate an answer to a question that is input by inputting instruction text that makes an instruction to list queries by which each user corresponding to the to-be-analyzed group is likely to make a search to the generative AI and scores each user who belongs to the to-be-analyzed group based on the acquired information on the queries.

6. The information processing device according to claim 5, wherein the provision unit specifies a query by which a search is made more by the warm-prospect user than by the to-be-compared user and a URL that is visited more by the warm-prospect user than by the to-be-compared user from a result of comparison between a search history and a browsing history of the warm-prospect user and a search history and a browsing history of the to-be-compared user.

7. An information processing method comprising:
setting a condition for a user who is classified into a user group from input data that is input by an operator;
selecting a to-be-analyzed group based on an attribute of a user corresponding to each condition with respect to each the condition;
scoring each user who meets the condition based on a behavior history of each user corresponding to each condition with respect to each the condition;
extracting a warm-prospect user whose score is higher than those of other users in the to-be-analyzed group based on a result of scoring performed by the scoring; and
selecting a to-be-compared user who is to be compared with the warm-prospect user from the to-be-analyzed group, specifying information on a characteristic behavior of the warm-prospect user from a result of comparison between behavior information on the warm-prospect user and behavior information on the to-be-compared user, transmitting information on the specified characteristic behavior and attribute information indicating the attribute corresponding to the warm-prospect user to a terminal device that the operator uses, and thus providing the specified information and the attribute information on the operator.

8. A non-transitory computer-readable storage medium storing an information processing program for causing the computer to execute:
setting a condition for a user who is classified into a user group from input data that is input by an operator;
selecting a to-be-analyzed group based on an attribute of a user corresponding to each condition with respect to each the condition;
scoring each user who meets the condition based on a behavior history of each user corresponding to each condition with respect to each the condition;
extracting a warm-prospect user whose score is higher than those of other users in the to-be-analyzed group based on a result of scoring performed by the scoring; and
selecting a to-be-compared user who is to be compared with the warm-prospect user from the to-be-analyzed group, specifying information on a characteristic behavior of the warm-prospect user from a result of comparison between behavior information on the warm-prospect user and behavior information on the to-be-compared user, transmitting information on the specified characteristic behavior and attribute information indicating the attribute corresponding to the warm-prospect user to a terminal device that the operator uses, and thus providing the specified information and the attribute information on the operator.
